(19) United States
(12) Patent Application Publication
(10) Pub. No.: US 2005/0235037 A1
(43) Pub. Date: Oct. 20, 2005

(54) Method and computer for sending an electronic document

(76) Inventor: Heiko Tropartz, Alsdorf (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/086,071

(22) Filed: Mar. 22, 2005

(30) Foreign Application Priority Data
Mar. 25, 2004 (DE) 10 2004 014 725.6

(51) Int. Cl. G06F 15/16; H04Q 7/20

(52) U.S. Cl. 709/206; 455/466

(57) ABSTRACT

The invention relates to a method for sending an electronic document using a computer and to a computer for this purpose, with one entry (K1, K2, KN) being selected as recipient from a plurality of entries (K1, K2, KN) in an address directory (AV), and a communication address being retrieved from the address directory (AV). The document and the communication address are sent to a communication application. To this end, a graphical user interface (BO) is used to display at least one entry (K1, K2, KN) from the address directory (AV), the document is represented on the graphical user interface (BO) by an element (D1, D2, D3, DN), the element (D1, D2, D3, DN) is moved by a selection means to one of the displayed entries (K1, K2, KN) and is released there. The electronic document and an address information item (E1, E2, EN, T1, T2, TN, F1, F2, FN, B1, B2, BN) associated with the selected entry in the address directory (AV) are transmitted as the communication address to the communication application for the purpose of sending.

### CROSS REFERENCE TO RELATED APPLICATIONS

This application claims priority to the German application No. 10 2004 014 725.6, filed Mar. 25, 2004 and which is incorporated by reference herein in its entirety.

### FIELD OF INVENTION

The invention relates to a method for sending an electronic document using a computer and to a computer for sending an electronic.

### BACKGROUND OF INVENTION

Electronic communication is frequently carried out using computers. In this case, the computers which can be used include not only the “classical” desktop PCs (multimedia PCs) but also mobile appliances such as PDAs (Personal Digital Assistants), mobile radios, portable computers (“Notebooks”) etc.

One known example of electronic communication is the medium “e-mail”, where a text which is input by a user is sent to a recipient using a communication application, the e-mail program. In this case, the recipient has a specific associated communication address for this medium, the e-mail address, this e-mail address frequently being taken from an address directory (contact list) stored on the computer. In this case, this address directory is often part of the communication application, that is to say the e-mail program.

The e-mail programs are frequently used not only to send pure text information but also to send other electronic documents, which in this context are either converted into the format of the e-mail, that is to say into a text, or else are added to the e-mail message as an attachment and are transferred to the recipient together with the e-mail message.

To link the electronic document which is to be sent to an e-mail message, the user has various options available. First, many e-mail programs allow a file selection window to be used to search for the electronic document which is to be sent in a directory structure on a computer and to define it as an attachment for the e-mail message. A second way is to integrate an additional function for sending an electronic document into that external application which is used to create the electronic document. Thus, by way of example, some word processing programs allow the text which is currently being edited to be sent to an e-mail program as a prepared attachment, which means that the attachment no longer needs to be defined using a file selection window in the e-mail program. A third option also allows a graphical element “icon” which represents the electronic document to be “dragged” into an e-mail message which is already being edited using a selection means (“mouse pointer”) by moving it over a graphical user interface. This method is also called “drag and drop”. After “dragging”, the user again selects a recipient with a suitable communication address (e-mail address) from an address list, or enters such a communication address manually into the e-mail message which is to be sent.

When sending electronic documents, it has been found to be a drawback that a user needs to perform a series of control steps manually. These include opening the associated communication application (for example the e-mail program), linking the electronic document to this communication application, ascertaining or inputting an appropriate communication address either from an address directory or by means of manual input, and sending the message with the electronic document.

Besides e-mail programs as communication applications, it is also possible to use other communication applications on a computer. Known examples of these are programs for electronically sending fax messages, telephony applications for carrying out voice communication, programs for sending and receiving mobile radio short messages (“SMS”=Short Messages Service”) etc. In this case, communication applications are also known which use a plurality of the outlined communication services, for example “unified messaging systems” (“UMS”), which can handle e-mail messages, fax messages and voice messages (e.g. telephone answering machine function). In this context, various types of electronic documents are used, for example audio files, text files, bitmap graphics etc. It has been found to be a drawback in this case that as the number of document types increases and as the number of communication services or communication applications increases it becomes more complex to use such a computer to send electronic documents.

By way of example, a user needs to select a suitable one of the installed communication applications in order to send an electronic document, in which case a plurality of different communication applications may also be suitable for the same electronic document, for example a text can be sent either as an e-mail message or as a fax message. In addition, the various communication services and hence also the various communication applications have different associated address information for one and the same recipient, said address information being used as the communication address. The user therefore needs to retrieve the e-mail address of the recipient from an address directory, or input it manually, in order to use an e-mail program, whereas telephone number information is used as the communication address for fax and voice messages. Finally, electronic documents can also be printed and sent by regular mail—in which case the address field of a corresponding letter naturally needs to contain the recipient's mailing address.

### SUMMARY OF INVENTION

It is thus an object of the present invention to simplify the sending of electronic documents using a computer.

The object is achieved by the claims.

The solution is a method for sending an electronic document using a computer, where sending involves one entry being selected as recipient from a plurality of entries in an address directory, and the selected recipient being used to retrieve a communication address from the address directory, the electronic document and the communication address being sent to a communication application, with the communication applications sending the electronic document to the communication address. In this case a graphical user interface is used to display at least one entry from the address directory, the document is represented on the graphical user interface by a moveable element, the element is moved by a selection means to one of the displayed entries as selected entry and is released there, and the electronic document represented by the element and address information associated with the selected entry in the address directory are transmitted as the communication address to the communication application for the purpose of sending the electronic document. This method allows a displayed document to be selected, by way of example, from a Windows-Explorer, Internet-Explorer or other listing and to be sent using the known “drag'n'drop” method, that is to say by “dragging” to an address book entry.

In this case, advantageously the application of rules (“routine rules”) automatically selects the best transmission medium and hence the preferred communication application to use. The criteria observed for selection are advantageously the type of document (file type), the content of the document (text, graphics, program code or the like) and the size of the document (memory requirement).

The object is also achieved by providing a computer for sending an electronic document, having an address directory with a plurality of entries, one entry being able to be selected as a recipient and the selected recipient being able to be used to retrieve a communication address from the address directory, and having a communication application, the electronic document and the communication address being able to be sent to the communication application, and the communication application being designed to send the electronic document to the communication address. The computer has a display means for displaying at least one entry from the address directory on a graphical user interface, comprises a representation means for representing the document on the graphical user interface using a moveable element, is equipped with a selection means for moving the element to one of the displayed entries as selected entry and for releasing the element after moving, and has a transmission means for sending the electronic document represented by the element and an address information item associated with the selected entry in the address directory to the communication application as the communication address, the communication application being designed to send the electronic document to the communication address. This computer can be used to send an electronic document to a selected recipient in just one control step (namely the known “drag'n'drop” method) by operating a selection means, for example a computer mouse, with the electronic document or a reference (“link”) thereto being transmitted to the communication application in a simple manner.

The method is advantageously developed by the features of the dependent patent claims. The features and advantages described therein apply in appropriate fashion to the inventive computer as well.

The sending of electronic documents is further simplified by virtue of the selected entry having a plurality of associated address information items associated with different types of documents, with the electronic document being sent by detecting the type of the electronic document after release and selecting an address information item which corresponds to this type as the communication address. In this case, the address information item to be used is thus selected using the type of the document which is to be sent, with an association between document type and address information type being obtained using presets (or by manual selection), for example.

If the at least one displayed entry is used to display a plurality of address information items, the element is released using the selection means at a particular one of the displayed address information items from the selected entry, and the particular address information item is used as communication address for sending the electronic document, then the user can select the address information item suited to the electronic document which is to be sent “manually”. In this case, the electronic document continues to be sent using a single control step, with just the screen position of the release (“of the drop”) determining the address information and hence the dispatch path.

If a plurality of communication applications can be used for respective different document types, and the electronic document is sent by selecting one of the communication applications which corresponds to the type of electronic document, the document being sent to the communication address by the selected one of the communication applications, then the electronic document can be sent by selecting the most suitable of the available communication applications. In this case, different communication applications may each have a different selectable address information item associated with them, which means that when releasing the element with the selection means at the appropriate address information item for the recipient this also determines the associated communication application which will therefore be used. One advantageous practice is also obtained if the respective document type also has an address information type linked to it, the address information type in turn being linked to a particular one of the communication applications. In that case, it is sufficient to release the element at the selected entry generally (that is to say on the recipient's name, for example), in which case both the correct instance of the available address information items and—linked thereto—the correct instance of the available communication applications is “automatically” selected.

When documents are sent in various ways, a subject line can give an idea of the content of the document or an idea of the more detailed circumstances of sending. To this end, a name for the electronic document and/or the selected entry is/are used to produce a subject line, this subject line being sent together with the electronic document. While the subject line is identified separately in the case of e-mail messages, for example, it can be added to the “overall document” which is to be sent when letters and faxes are being sent. In these cases, the communication application in question generates a new letter document or fax document, for example, by constructing the message which is to be sent as a “body” of text from the sender statement, the recipient statement, the (newly generated) subject line and the original document which is to be sent.

The inventive method can be used with tried-and-tested and thus easily usable appliances if the computer used is a personal computer, a PDA appliance or a mobile radio. In this case, the use of a computer mouse as the selection means provides a particularly well-known and tried-and-tested control appliance.

The exemplary embodiments of the inventive method are explained below with reference to the drawings and are simultaneously used to explain exemplary embodiments of computers based on the invention.

### BRIEF DESCRIPTION OF THE DRAWING

The sole FIGURE shows the user interface on a computer showing an address directory, a file management program and an Internet-page display program.

### DETAILED DESCRIPTION OF INVENTION

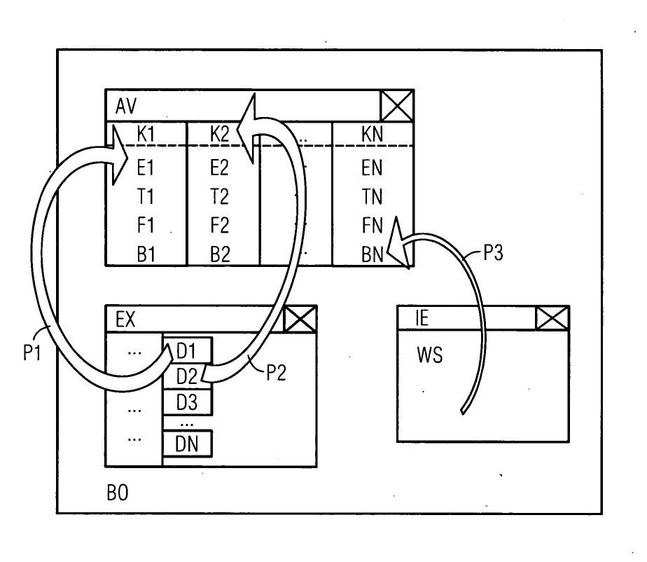

FIG. 1 shows the user interface BO of a computer, where the user interface BO displays an address directory AV, a file management program EX (“Windows Explorer”) and an Internet-page display program IE (“Internet Explorer”, that is to say a “web browser”), each in the form of windows.

The display window for the address directory AV displays various entries K1, K2, KN, these entries K1, K2, KN each having associated address information E1, E2, EN, T1, T2, TN, F1, F2, FN, B1, B2, BN. While the entries K1, K2, KN are always displayed at least as a name for an associated recipient, the address information associated with the respective entries K1, K2, KN can either be opened (that is to say displayed) or closed. The address information E1, E2, EN shown by way of example in the FIGURE is e-mail addresses, the address information T1, T2, TN is telephone numbers, F1, F2, FN are fax numbers and finally the address information B1, B2, BN is the letter addresses (postal address) associated with the respective elements K1, K2, KN. Instead of the address directory, it is also possible to use a “partner bar” or another address data source.

The file management program EX is a component of an operating system which is used to display files, messages and documents of various types which are stored on the computer as an element, that is to say with their file name or in the form of a symbol (“icon”). By way of example, the FIGURE shows the electronic documents D1, . . . , DN as elements, which are used below to explain the sending of electronic documents. However, the present method and the present computer may also be used in the same way to send documents (and other “data objects”) from the computer which are arranged directly on the user interface (“desktop”) or else are shown using other “applications”.

The third window shown in the FIGURE shows an Internet-page display program IE, that is to say a “web browser”, the web pages or parts thereof which are displayed using the Internet-page display program IE likewise being able to be sent as electronic documents using the methods described here or the computer described here.

The arrows P1, P2 shown in the FIGURE show, in symbol form, the moving of the electronic documents D1, D2 or the moving of display elements which represent these electronic documents D1, D2 to the address information item E1 (this relates to arrow P1) or to the entry K2 (arrow P2). Arrow P3 symbolically shows the movement and release (“drag'n'drop”) of a web page WS shown by the Internet-page display program IE to the address information item SN.

The computer whose user interface BO is shown in the FIGURE has a first communication application, a “unified messaging system” (“UMS system”) installed on it. The UMS system can be used to send and receive e-mail messages, fax messages and voice messages using a common user interface. A second communication application installed on the computer is a word processing program, which can create, print and send letters and similar text documents for automatic dispatch by ordinary mail.

The text below refers to the FIGURE to explain how a user of the computer uses movement and release (“drag'n'drop”) to send the electronic document D1 by e-mail to the e-mail address E1 of the recipient with the entry K1 (selected entry). To this end, the user moves the mouse pointer, as selection means, onto a symbol (“icon”) which represents the electronic document D1 in the form of an element, “drags” this element by holding down the left-hand mouse button (arrow P1) onto the address information item E1 (e-mail address of the entry K1) and releases the element there by virtue of the user releasing the left-hand mouse button again. The computer's operating system links this action to a command sequence which sends information (file name, file type, storage location) from the element D1 and the address information E1 as the communication address which is to be used by the communication application to the first communication application (UMS system) together with the command “send”. This command is executed by the UMS system in a known manner. In this context, the name of the element D1 is used to generate a subject line “transmission of document D1” which is used as a subject line (“subject”) for the e-mail message. In general, in all of the exemplary embodiments outlined, a subject line can be generated automatically, either depending on or regardless of the type of document which is to be sent.

The text below refers to the FIGURE to explain how the element D2, which is likewise listed in the file management program EX, is sent by “dragging” onto the entry K2. In this case, the element D2 or the electronic document linked to the element D2 is an audio file which needs to be transmitted using a telephone connection. The user “drags” the element D2 onto the entry K2 (in this case that is to say onto the name of the addressee with whom the entry K2 is associated) and releases the element D2 there (again by releasing the left-hand mouse button). As a result of this action, the operating system on the computer executes a program which establishes that the document type of the electronic document linked to the element D2 is the “audio file” type. By accessing a document type table, the program establishes that in the present configuration documents of the “audio file” type need to be transmitted to the addressee via a telephone connection using the first communication application “UMS system”.

Instead of simply accessing the document type table or the manual selection of the address information, it is also possible to apply more complex rules (“routing rules”). By way of example, these may define that mixed documents (combined graphics files and text files or application program files) need to be sent as an e-mail message, line graphics (black and white pictures) need to be sent as a fax message, short texts (<160 characters) need to be sent as an SMS message and very large documents (taking up a large amount of memory space) need to be sent as an e-mail message (which may optionally also be compressed).

The program now transfers an appropriate command, together with a reference (“link”) to the electronic document in question, with an “audio subject line” and with the address information T2 (telephone number of the addressee), to the first communication application “UMS system”. The “audio subject line” is a synthetically produced audio file which comprises the content “User XY sends herewith audio document D2”. The UMS system now uses a plug-in telephone card (e.g. ISDN card) present in the computer to dial the addressee's telephone number and, when the call has been accepted, successively plays back the audio file from the “audio subject line” and then the electronic document D2 as a further audio file.

The next exemplary embodiment explains how the Internet page WS is sent by ordinary mail by means of simple movement (“drag'n'drop”; arrow P3). Alternatively, the UMS system can likewise be used to send a fax message. The user drags an arbitrary element from the Internet page WS onto the address information BN from the entry KN. Following release, under the control of the operating system on the computer, a conversion program is started which reads the Internet page WS from the Internet-page display program IE and converts it into a text format which is supported by the second communication application (the word processing program). This converted Internet page is sent to the word processing program together with the letter address (address information BN) and the subject line (“Internet page XY”). Alternatively, a dialog window may also be opened in which the user can create a subject line.

The program now assembles the letter address (address information BN), a sender address, the subject line and, as the body of the text, the converted Internet page WS to form a letter document which is now output by the word processing program to a letter output station, that is to say an external appliance. The letter output station then prints the letter document, puts it into an envelope, franks it and provides it for transport.

In one particular embodiment, the sender address may also be produced from a control mechanism, for example such that for e-mail messages the e-mail address of the user is used, while for fax messages either the letter address or a fax telephone number for the sender (user) is used. A similar control mechanism can be set up, as mentioned, for the optional subject line which is to be produced.

In the latter case too, the electronic document may also be released generally on the entry KN instead of the address information BN; this presupposes that an accessible table (list, file) stores the information that Internet pages need to be sent by means of the word processing program as communication application using letter addresses (“B1, B2, BN”). It goes without saying that a document type may also have a plurality of linked communication applications or a plurality of linked address information types; in such cases, a selection window opens for the user, who can use it to select a preferred option from the options described either for the present case or for all future cases.

1-19. (canceled)

20. A method for sending an electronic document using a computer, the method comprising:
displaying at least one entry of an address directory on a graphical user interface;
representing the document on the graphical user interface by an element moveable on the graphical user interface;
moving the element by a selection mechanism to one of the displayed entries and releasing the element; and
selecting a transmission medium based on properties of the document and a set of rules, wherein
the electronic document represented by the element and address information associated with the selected transmission medium and included in the address directory are transmitted to a communication application associated with the transmission medium for the purpose of sending the electronic document, the address information used as a communication address by the communication application.

21. The method as claimed in patent claim 20, wherein the properties of the document are determined by evaluating the content of the document.

22. The method as claimed in patent claim 21, wherein, when evaluating the content using the rules, a distinction is made at least between graphics, text, and application programs.

23. The method as claimed in patent claim 20, wherein short texts are sent as an SMS message, and documents taking up a large amount of memory space are sent as an e-mail message.

24. The method as claimed in patent claim 20, wherein the transmission medium used is an e-mail service, a fax service or an SMS service.

25. The method as claimed in patent claim 20, wherein a name for the electronic document and/or the selected entry is/are used to create a subject line, this subject line being sent with the electronic document.

26. The method as claimed in patent claim 20, wherein the computer is a personal computer, a PDA device, or a mobile radio.

27. The method as claimed in patent claim 20, wherein the selection mechanism is a computer mouse.

28. A method for sending an electronic document using a computer, the method comprising:
selecting an entry as a recipient from an address directory;
retrieving a communication address from the address directory on the basis of the selected recipient;
transmitting the electronic document and the communication address to a communication application; and
transmitting the electronic document to the communication address by the communication application, wherein
the entry is displayed on a graphical user interface,
the document is represented on the graphical user interface by an element moveable on the graphical user interface,
the element is moved by a selection mechanism to the displayed entry,
the element is released at the displayed entry,
the electronic document and an address information associated with the selected entry is transmitted to the communication application, and
the electronic document is transmitted by the communication application using the address information as a communication address.

29. The method as claimed in patent claim 28, wherein short texts are sent as an SMS message, and documents taking up a large amount of memory space are sent as an e-mail message.

30. The method as claimed in patent claim 28, wherein the displayed entry is used to display a plurality of address information items, wherein the element is released using the selection mechanism at a particular one of the displayed address information items from the selected entry, and wherein the particular address information item is used as communication address for sending the electronic document.

31. The method as claimed in patent claim 28, wherein the selected entry has a plurality of associated address information items associated with different types of documents, wherein the electronic document being sent by detecting a type for the electronic document after release and selecting an address information item which corresponds to this type as the communication address.

32. The method as claimed in patent claim 28, wherein a plurality of communication applications can be used for respective different document types, and wherein the electronic document is sent by selecting one of the communication applications which corresponds to the type of electronic document, the document being sent to the communication address by the selected communication application.

33. The method as claimed in patent claim 28, wherein an identifier for the electronic document and/or the selected entry is/are used to produce a subject line, this subject line being sent with the electronic document.

34. The method as claimed in patent claim 28, wherein the computer used is a personal computer, a PDA, or a mobile radio.

35. The method as claimed in patent claim 28, wherein the selection mechanism used is a computer mouse.

36. A computer for sending an electronic document, comprising:
an address directory having a plurality of entries, each entry selectable as a recipient and the selected recipient used to retrieve a communication address from the address directory;
a communication application configured to receive the electronic document and the communication address and configured to send the electronic document to the communication address;
a display mechanism for displaying at least one entry of the address directory on a graphical user interface;
a representation mechanism for representing the document as an element moveable on the graphical user interface;
a selection mechanism for moving the element to one of the displayed entries and for releasing the element after moving for selecting the entry; and
a transmission mechanism for sending the electronic document and an address information item associated with the selected entry to the communication application, wherein the address information item is included in the address directory and used as communication address.

37. The computer as claimed in patent claim 36, further comprising a detection mechanism for acquiring a type for the document which is to be sent, the detection mechanism being designed to select an address information item corresponding to the type from a plurality of type-related address information items associated with the recipient as the communication address.

38. The computer as claimed in patent claim 36, further comprising a generation device for creating a subject line, the subject line being able to be created from the name, from the content and/or from the type of document, and the communication application being designed to send the created subject line with the document.

39. The computer as claimed in patent claim 37, further comprising a generation device for creating a subject line, the subject line being able to be created from the name, from the content and/or from the type of document, and the communication application being designed to send the created subject line with the document.
